(19) United States
(12) Patent Application Publication
(10) Pub. No.: US 2002/0105795 A1
(43) Pub. Date: Aug. 8, 2002

(54) Backlight keyboard

(76) Inventor: Yaolung Huang, Taipei (TW)

Correspondence Address: R . P. Gilly Intellectual Property,, Law Offices, P.C., Suite 1500, One Penn Center, 1617 John F. Kennedy Blvd., Phila, PA, 19103-1815, US

(21) Appl. No.: 09/775,700

(22) Filed: Feb. 2, 2001

(51) Int. Cl. F21V 33/00

(52) U.S. Cl. 362/85; 362/31; 362/26; 345/170

(57) ABSTRACT

A backlight keyboard is connected to a host device via a signal line. The keyboard includes a plurality of keys, a light source power-supplied by the host device via the signal line and a light guide disposed under the plurality of keys for guiding and uniformly spreading the light transmitted from the light source

### FIELD OF THE INVENTION

The present invention relates to a keyboard, and more particularly to a backlight keyboard.

### BACKGROUND OF THE INVENTION

Due to the fast development of information technology, a computer device with more and better new functions is desired. Furthermore, with the need of simplifying control and operation of the computer, various data input apparatus are developed accordingly. Among them, the keyboard is the most long-standing, basic and hardly replaceable data input apparatus now.

It is not convenient to input data and command through the keyboard in an environment of an insufficient light or in darkness even if the user is familiar with relative locations of keys. Equipping the keyboard with a light source solves the problem. It is therefore tried by the applicant to provide a keyboard with a light source which is more suitable for computers.

### SUMMARY OF THE INVENTION

It is therefore an object of the present invention to provide a backlight keyboard for a user's operation in an environment of insufficient light or in darkness.

It is further an object of the present invention to provide a backlight keyboard connected to a host device, wherein the light source is controlled by the host device.

It is still an object of the present invention to provide a backlight keyboard capable of detecting surrounding luminosity and automatically turning on the light source when a low surrounding luminosity is detected.

It is additional an object of the present invention to provide a backlight keyboard which is power-supplied by the host device connected thereto rather than an additional power source.

It is more an object of the present invention to provide a backlight keyboard with a hotkey, in which the light source is turned on or off when the hotkey is pressed.

According to the present invention, a backlight keyboard is adapted to be electrically connected to a host device via a signal line. The keyboard includes a plurality of keys, a light source and a light guide. The light source is adapted to be power-supplied by the host device via the signal line. The light guide is disposed under the plurality of keys for guiding the light transmitted from the light source.

The host device is preferably a personal computer.

The light source is preferably a light-emitting diode (LED).

The backlight keyboard can further comprise a photo sensor (CDS photocell) electrically connected to the light source for detecting the surrounding luminosity and the light source is turned on when the detected surrounding luminosity is lower than a threshold value.

The backlight keyboard can further comprise a hotkey whereby the light source is controlled.

Preferably, the light source can be directly controlled by the host device.

Preferably, each of the plurality of keys is made of a transparent material.

Preferably, the light guide can uniformly spread the light under the plurality of keys.

The present invention may best be understood through the following descriptions with reference to the accompanying drawings, in which:

### BRIEF DESCRIPTION OF THE DRAWING

FIG. 1 is a schematic view showing a preferred embodiment of the backlight keyboard according to the present invention; and

FIG. 2 is a schematic view showing an architecture of a backlight keyboard uniformly spreading the light by the multiple LEDs and the light guide according to the present invention.

### DETAILED DESCRIPTION OF THE PREFERRED EMBODIMENTS

The present invention will now be described more detailedly with reference to the following embodiment. It is to be noted that the following descriptions of the preferred embodiments of this invention are presented herein for the purpose of illustration and description only. It is not intended to be exhaustive or to be limited to the precise from disclosed.

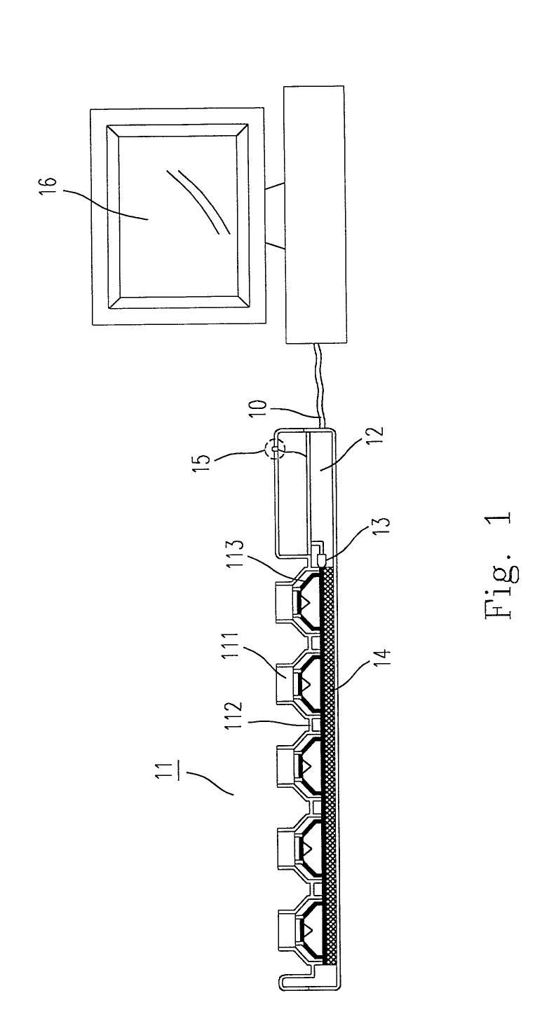

Referring now to FIG. 1, there is shown a preferred embodiment of a backlight keyboard adapted to be electrically connected to a host device, e.g. a personal computer 16 via a signal line 10. The keyboard includes a plurality of keys 11 for performing a data-input function, a light source 13 adapted to be power-supplied by the personal computer 16 via the signal line 10, and a light guide 14 disposed under the plurality of keys 11 for guiding and uniformly spreading the light transmitted from the light source 13.

A signal line 10 is connected to a PS2 or USB keyboard connector (not shown) in the personal computer 16. Each of the keys 11 comprises a key cap 111, an upper cover 112 and a rubber pad 113, whereby a transparent area is formed. The input data produced by a user's strokes of the keys 11 is received by the encoder (not shown) in the circuit board 12 and is encoded into a control signal to the personal computer 16.

In order to make possible a user's operation of the backlight keyboard in an environment of insufficient light or in darkness, a light source 13 and a light guide 14 are provided. The light guide 14 guides and uniformly spreads the light transmitted from the light source 13. Although the light source 13 and light guide 14 are similar to those commonly used in a liquid crystal display, the additional power source used for the cold cathode lamp of the LCD is no longer needed in the present invention. Instead, the light source 13 is directly power-supplied by a DC voltage provided by the personal computer 16 via the signal line 10.

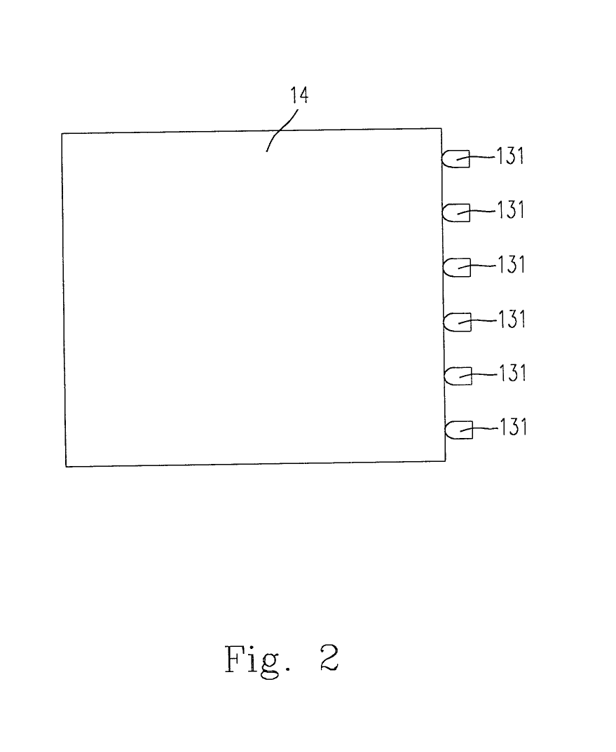

Referring now to FIG. 2, the light source 13 in FIG. 1 preferably comprises one or more Light Emitting Diodes (LEDs) 131. The number of the LEDs depends on the required transparent area. There are many reflective points (not shown) within the light guide 14 for vertically reflecting the light which is horizontally transmitted from the LEDs 131 .The area of the reflective points is proportional to the distance from the light source. Thus makes it possible to uniformly spread the light from the LEDs 131 in the light guide 14.

There are different control methods for the light source 13.

First, a hotkey is added to or assigned in the backlight keyboard. The light source 13 is turned on or off when the hotkey is pressed.

Second, a photo sensor 15 (CDS photocell) in the backlight keyboard is used for detecting the surrounding luminosity. The light source 13 is turned on when the detected surrounding luminosity is lower than a threshold value.

Third, the light source 13 is directly controlled by the personal computer 16. The light source 13 is turned on when the personal computer 16 receives an E-mail or message via the Internet. Thus, users can be reminded by the backlight keyboard.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

What claimed is:

1. A backlight keyboard which is adapted to be electrically connected to a host device via a signal line, said keyboard comprising:
a plurality of keys;
a light source power-supplied by said host device via said signal line; and
a light guide disposed under said plurality of keys for guiding said light transmitted from said light source.

2. The backlight keyboard according to claim 1, wherein said host device is a personal computer.

3. The backlight keyboard according to claim 1, wherein said light source is a light-emitting diode (LED).

4. The backlight keyboard according to claim 1 further comprising a photo sensor electrically connected to said light source for detecting surrounding luminosity, wherein said light source is turned on when the surrounding luminosity detected by said photo sensor is lower than a threshold value.
